(19) United States
(12) Patent Application Publication
(10) Pub. No.: US 2015/0170561 A1
(43) Pub. Date: Jun. 18, 2015

(54) DISPLAY DEVICE AND METHOD OF DRIVING THE SAME

(71) Applicant: SAMSUNG DISPLAY CO., LTD., Yongin-City (KR)

(72) Inventors: Jeong Keun AHN, Suwon-si (KR); Baek Woon LEE, Yongin-si (KR)

(21) Appl. No.: 14/518,038

(22) Filed: Oct. 20, 2014

(30) Foreign Application Priority Data
Dec. 17, 2013 (KR) 10-2013-0157181

(51) Int. Cl. G09G 3/20; G09G 3/00

(52) U.S. Cl. CPC G09G 3/2022; G09G 3/003; G09G 2340/16; G09G 2310/0205; G09G 2310/0267; G09G 2310/0275; G09G 2360/12

(57) ABSTRACT

A display device includes a display unit, a scan driver unit, and a data driver. The display unit includes a plurality of pixels arranged in a matrix. The matrix includes a first pixel row block and a second pixel row block. The scan driver unit includes a first scan driver to sequentially transmit a first scan signal in each frame to the first pixel row block, and a second scan driver to sequentially transmit the first scan signal in each frame to the second pixel row block. The data driver inputs first frame image data for a first time to the display unit in an n-th frame and to input the first frame image data for a second time to the display unit in an (n+1)-th frame.

### CROSS-REFERENCE TO RELATED APPLICATION

Korean Patent Application No. 10-2013-0157181, filed on Dec. 17, 2013, and entitled, “DISPLAY DEVICE AND METHOD OF DRIVING THE SAME,” is incorporated by reference herein in its entirety.

### BACKGROUND

1. Field

One or more embodiments described herein relate to a display device and a method of driving the same.

2. Description of the Related Art

A variety of flat panel displays have been developed. Examples include liquid crystal displays, field emission displays, plasma display panels, and organic light-emitting displays.

These display devices display frame images. To display a frame image, the frame image may sequentially input to rows of pixels in the order in which pixel rows are scanned. Thus, pixel rows that receive the frame image later may display an image of a previous frame, until a next frame begins. Such a display device may therefore include pixel rows that display a current frame image and pixel rows that display a previous frame image.

Sequentially displaying different frame images in one frame corresponds to one image presentation technique. However, this technique may cause a deterioration in image quality in some cases. For example, a three-dimensional (3D) image display device alternately displays a left-eye image and a right-eye image to a person. However, if the left-eye image and the right-eye image are mixed in one frame, it may be difficult to recognize an accurate 3D image.

### SUMMARY

In accordance with one embodiment, a display device includes a display unit including a plurality of pixels arranged in a matrix, the matrix including a first pixel row block and a second pixel row block; a scan driver unit including a first scan driver to sequentially transmit a first scan signal in each frame to the first pixel row block and a second scan driver to sequentially transmit the first scan signal in each frame to the second pixel row block; and a data driver to input first frame image data for a first time to the display unit in an n-th frame and to input the first frame image data for a second time to the display unit in an (n+1)-th frame.

The first frame image data may be input to each of the pixels for one frame period, after the first scan signal in each frame is transmitted to each of the pixels. A number of the pixel rows in the first pixel row block may be equal to a number of the pixel rows in the second pixel row block.

A period of time, from when the first scan signal in each frame is transmitted first to each pixel row block to when the first scan signal in each frame is transmitted last to each pixel row block, may be substantially equal to one frame period.

The second pixel row block may be directly below the first pixel row block, the first scan signal in each frame may be sequentially transmitted along a first direction in the first pixel row block, and the first scan signal in each frame may be sequentially transmitted along a second direction, which is opposite to the first direction, in the second pixel row block.

The data driver may input second frame image data for a first time to the display unit in an (n+2)-th frame, and may input a second frame image data for a second time to the display unit in an (n+3)-th frame. The (n+1)-th frame may be an unmixed image frame in which only a first frame image data is input, and the (n+2)-th frame may be a mixed image frame in which the first frame image data and second frame image data are input together. Each of the pixels may include a light-emitting element which does not emit light in the unmixed image frame.

The display device may include a driving unit including a first power source to supply a first driving voltage and a second power source to supply a second driving voltage. The second power source may cause the light-emitting element to emit light according to input frame image data by supplying the second driving voltage at a first level during the unmixed image frame, and may cause the light-emitting element to not emit light regardless of the input frame image data by supplying the second driving voltage at a second level during the mixed image frame.

The first frame image data may be left-eye image data and the second frame image data may be right-eye image data.

The second pixel row block may be directly below the first pixel row block, and a direction in which the first scan signal in each frame may be transmitted sequentially to the first pixel row block is equal to a direction in which the first scan signal in each frame is transmitted sequentially to the second pixel row block.

The data driver may input first frame image data for a third time to the display unit in the (n+2)-th frame, input second frame image data for a first time to the display unit in the (n+3)-th frame, input the second frame image data for a second time to the display unit in an (n+4)-th frame, and input the second frame image data for a third time to the display unit in an (n+5)-th frame. The first frame image data may be input to each of the pixels for one frame period, after the first scan signal in each frame is transmitted to each pixel.

The first scan driver and second scan driver may be located on separate driver integrated circuit (IC) chips.

The first scan signal in each frame may be transmitted alternately to each pixel row of the first pixel row block and each pixel row of the second pixel row block, and the first scan signal in each frame may be transmitted to the first pixel row block and the second pixel row block at different times. Each of the first frame image data and the second frame image data may include a plurality of subframe data.

In accordance with one embodiment, a display device includes a display unit including a plurality of pixels arranged in a matrix, the matrix including a plurality of pixel row blocks; and a driving unit to provide a driving signal to the display unit, wherein the driving unit sequentially scans each of the pixel row blocks and provides same frame image data to the display unit for two or more successive frames. The driving signal may include a blocking signal to block display of the display unit for at least one of the two or more successive frames.

In accordance with another embodiment, a method of driving a display device includes generating first frame image data based on image data from an image source; sequentially inputting the first frame image data for a first time to each of a plurality of pixel blocks of the display device, while transmitting a non-emission driving signal to each pixel of the display device during a first frame; and inputting the first frame image data for a second time to the pixels of each pixel block of the display device, while transmitting an emission driving signal to each pixel of the display device during a second frame following the first frame.

The method may include generating second frame image data based on image data from the image source; sequentially inputting the second frame image data for a first time to each pixel block of the display device, while transmitting the non-emission driving signal to each pixel of the display device during a third frame following the second frame; and inputting the second frame image data for a second time to the pixels of each pixel row block of the display device, while transmitting the emission driving signal to each pixel of the display unit during a fourth frame following the third frame.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates a relationship between each pixel and frame image data;

FIG. 3 illustrates an embodiment of a display unit;

FIG. 4 illustrates a selection order of a scan driver according to an embodiment;

FIG. 5 illustrates a period of time during which a frame image is realized by each pixel row of the display unit according to one embodiment;

FIG. 6 illustrates a period of time during which a frame image is realized by each pixel row of the display unit according to another embodiment;

FIG. 7 illustrates frame image data of a driving unit for one embodiment;

FIG. 8 illustrates a pattern in which frame image data is input to each pixel row with respect to time according to one embodiment;

FIGS. 9 through 15 illustrate patterns in which frame image data is input to each pixel row with respect to time for various other embodiments;

FIG. 16 illustrates an embodiment of a display device according;

FIG. 17 illustrates an embodiment of one pixel in FIG. 16;

FIG. 18 illustrates an embodiment of a pixel driving method;

FIG. 19 illustrates another embodiment of a pixel driving method;

FIG. 20 illustrates a driving waveform diagram of a display device in each frame according to an embodiment; and

FIG. 21 illustrates a driving waveform diagram of a display device in each frame according to another embodiment.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

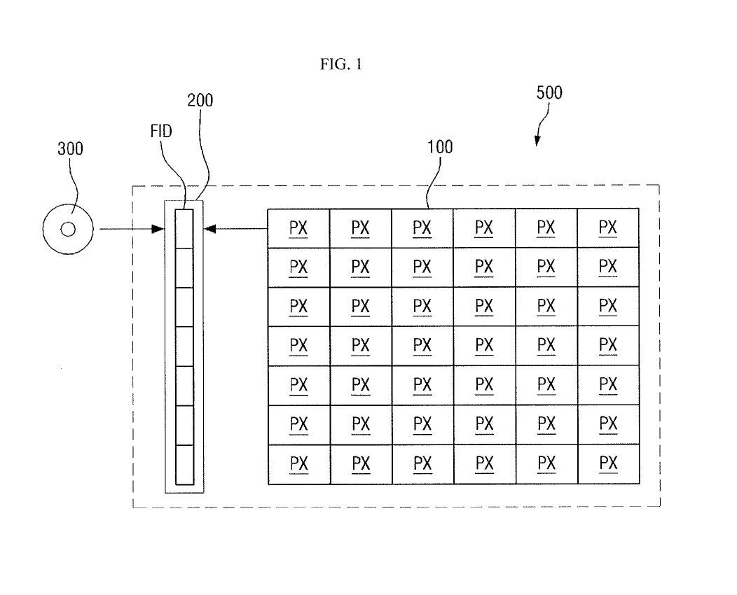

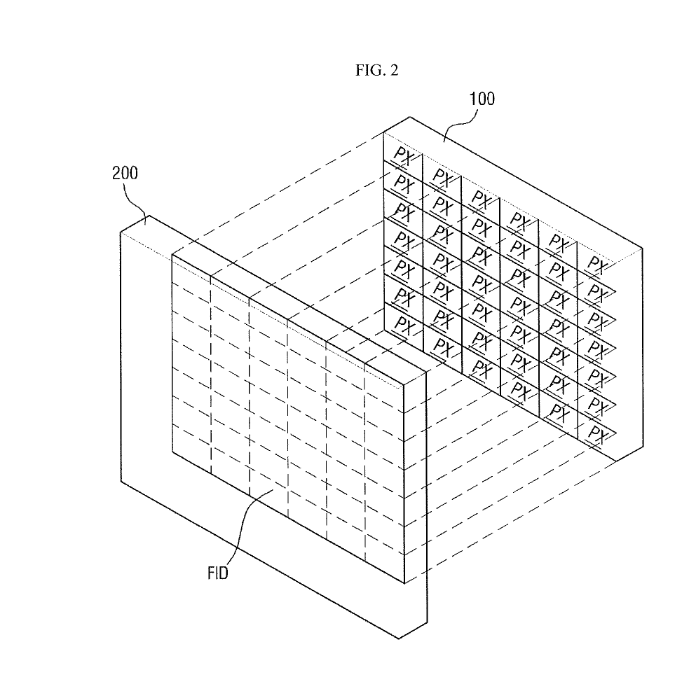

FIG. 1 illustrates an embodiment of a display device 500, and FIG. 2 illustrates a relationship between each pixel PX and frame image data (FID). Referring to FIGS. 1 and 2, display device 500 includes a display unit 100 and a driving unit 200.

The display unit 100 includes a plurality of pixels PX arranged in a matrix.

The driving unit 200 receives image data ID from image source 300, and generates frame image data FID using the image data ID. The driving unit 200 stores the frame image data FID and provides the frame image data FID to display unit 100.

The frame image data FID may include data on an image (or luminance) to be displayed by each pixel PX in a specific frame. The frame image data FID may be converted into a voltage or current signal and transmitted to respective ones of the pixels PX. (The expression “the frame image data FID is input to each pixel PX or the display unit 100” may be understood to mean that a signal based on frame image data FID is transmitted to each pixel PX or the display unit 100 by, e.g., a data driver).

Using the received signal, each pixel PX may output light to form an image (i.e., luminance) corresponding to the frame image data FID during one frame. In one example, one driving signal corresponding to frame image data FID may be transmitted to one pixel PX. In this case, the pixel PX may maintain the driving signal during one frame period, to thereby realize a corresponding image.

In another example, a plurality of driving signals may be transmitted to one pixel PX during one frame period. As a result, a corresponding image may be realized. In this case, the number of driving signals, the size of each of the driving signals, and the transmission duration of each of the driving signals may be controlled to control the luminance of each pixel of the image.

Each pixel PX may realize an image in a different way according to the type of display device 500. In one example, if display device 500 is a liquid crystal display including a non-emitting element, a corresponding image and luminance may be realized by controlling an azimuth of liquid crystal molecules using a driving signal and by controlling the output of backlight.

If the display device 500 is an organic light-emitting display, a plasma display panel, or a field emission display which include self-emitting elements, an image and luminance of each pixel PX may be realized by controlling the amount or duration of light emission using a driving signal.

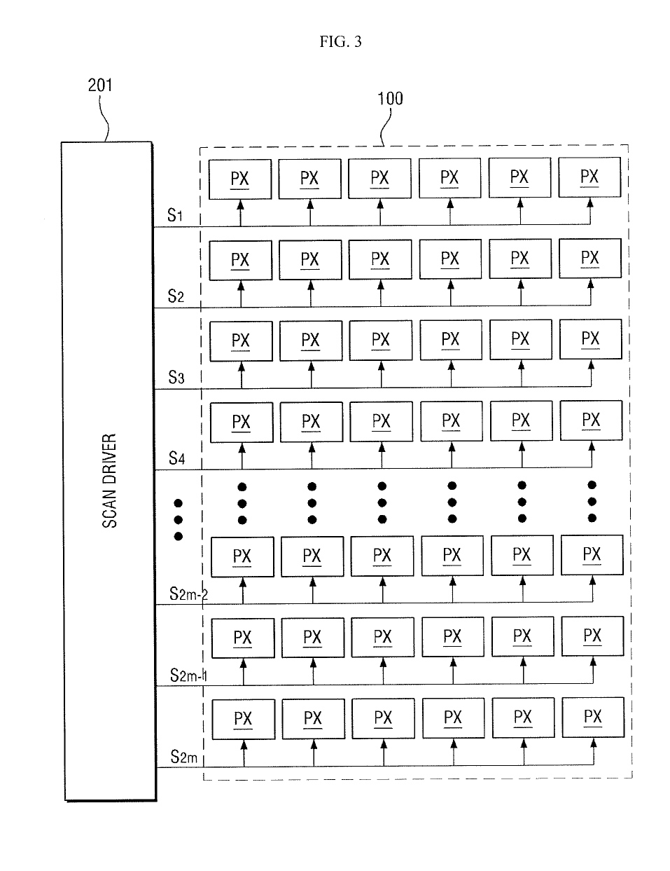

FIG. 3 illustrates an embodiment of a display unit, which, for example, may be display unit 100 of FIG. 1. Referring to FIG. 3, the display unit 100 may include a plurality of scan lines S1 through S2m. Each of the scan lines S1 through S2m may extend in a row direction.

Each of the scan lines S1 through S2m may receive a scan signal from a scan driver 201 and may transmit the received scan signal to each pixel PX. The scan signal may select transmission of a driving signal. To this end, the scan signal may include a selection signal and a non-selection signal. When the selection signal is transmitted to each pixel PX, a driving signal such as a data voltage or a power supply voltage may be transmitted to each pixel PX. When the non-selection signal is transmitted to each pixel PX, the transmission of the driving signal to each pixel PX may be blocked.

Each of scan lines S1 through S2m may correspond to a row of pixels PX. For example, each of scan lines S1 through S2m may be electrically connected to a plurality of pixels PX included in a corresponding pixel row, and may deliver a scan signal to the pixels PX. When a scan signal is provided to a scan line, it may be delivered to all pixels PX of a corresponding pixel row substantially simultaneously. Here, the term “substantially simultaneously” may encompass not only exactly the same time, but also a fine difference between times when the scan signal is first delivered to the pixels PX due to a signal delay in the wiring.

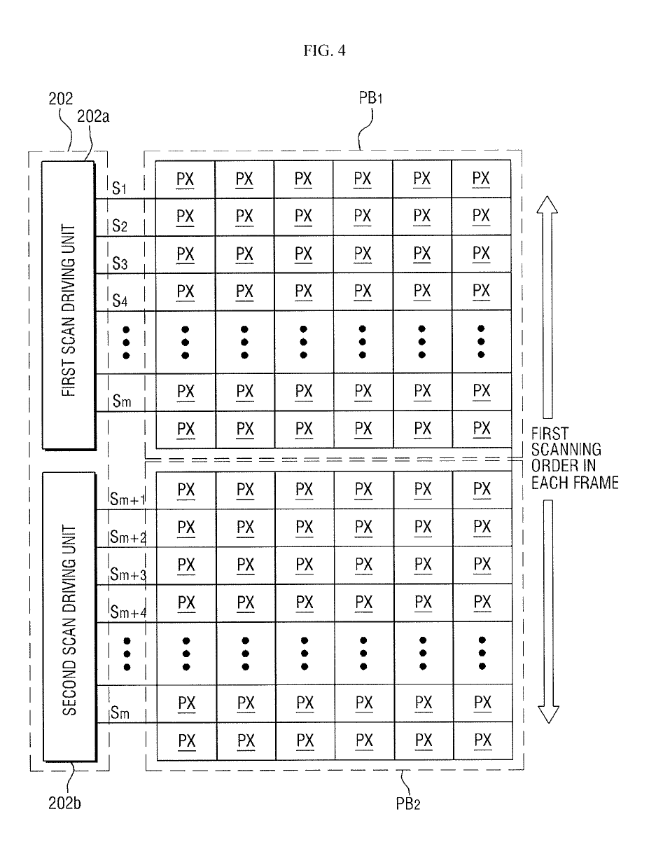

FIG. 4 illustrates an embodiment of a selection order of a scan driver 202. Referring to FIG. 4, a first scan signal (for reflecting frame image data) in each frame may be transmitted to each pixel row at a different time. The first scan signal may be a scan initiation signal for a corresponding row in a corresponding frame.

For example, the first scan signal may be transmitted sequentially to neighboring pixel rows. Specifically, pixel rows may be divided into a plurality of pixel row blocks (PB1, PB2). The first scan signal in a frame may be transmitted sequentially to pixel rows in each of the pixel row blocks (PB1, PB2).

In one embodiment, a display unit may include a first pixel row block PB1 and a second pixel row block PB2. The first and second pixel row blocks PB1 and PB2 may include, but are not limited to, equal numbers of pixel rows. In one embodiment, the first pixel row block PB1 may include an upper half of the pixel rows. The second pixel row block PB2 may include a lower half of the pixel rows.

A first scanning order of the first pixel row block PB1 in each frame may be a first direction, for example, from a lowest row to a highest row. A first scanning order of the second pixel row block PB2 in each frame may be a second direction, which is opposite to the first direction, for example, from a highest row to a lowest row. The first pixel row block PB1 may be scanned, on a row-by-row basis, over the entire frame. The second pixel row block PB2 may be scanned, on a row-by-row basis, over the entire frame. For example, pixel row blocks may not be scanned sequentially (e.g., in an order in which after a pixel row block is scanned on a row-by-row basis, another pixel row block is scanned on a row-by-row basis). Instead, all pixel row blocks (PB1, PB2) may be scanned substantially simultaneously, on a row-by-row basis, during the entire frame period.

The scan driver 202 may provide scan signals sequentially to pixel rows of each pixel row block (PB1, PB2). To this end, the scan driver 202 may include a plurality of scan driving units (202a, 202b) which match pixel row blocks (PB1, PB2). In one embodiment, the scan driver 202 may include a first scan driving unit 202a and a second scan driving unit 202b. The first scan driving unit 202a may provide scan signals to the first pixel row block PB1. The second scan driving unit 202b may provide scan signals to the second pixel row block PB2. The first scan driving unit 202a and second scan driving unit 202b may be implemented as separate driver integrated circuit (IC) chips.

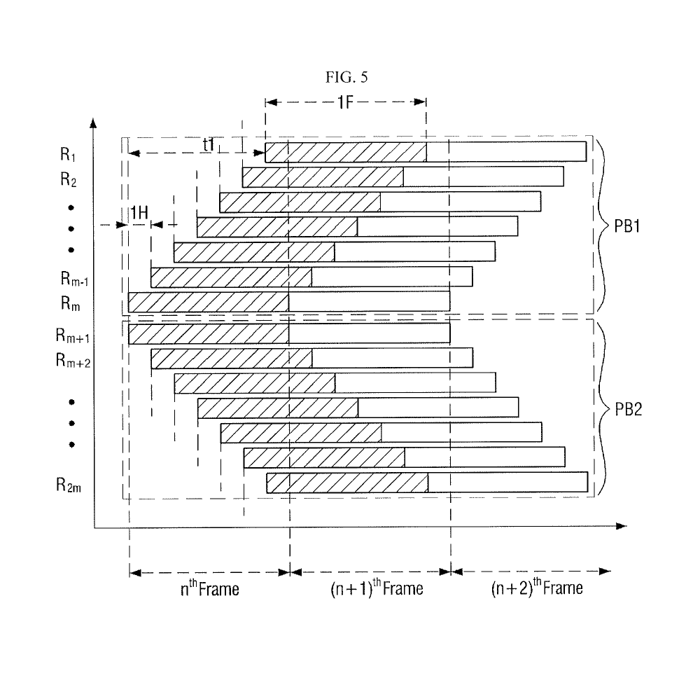

FIG. 5 illustrates a period of time during which a frame image is realized by each pixel row of a display unit according to one embodiment.

Referring to FIG. 5, a first scan signal for reflecting nth frame image data may be sequentially transmitted to a first pixel row block PB1 in an upward direction from a lowest pixel row Rm. In addition, the first scan signal for reflecting the nth frame image data may be sequentially transmitted to a second pixel row block PB2 in a downward direction from a highest pixel row Rm+1.

The first scan signal may be transmitted to neighboring pixel rows with a time interval of 1 horizontal period (1H). A period of time t1, from when the first scan signal is transmitted for the first time to each pixel row block (PB1, PB2) to when the first scan signal is transmitted for the last time to each pixel row block (PB1, PB2), may be substantially equal to one frame period 1F.

When “the period of time t1 is substantially equal to one frame period 1F,” the period of time t1 may be exactly equal to one frame period 1F or almost close to one frame period 1F. For example, even if the period of time t1 is 90% or more of one frame period 1F, it may be interpreted that the period of time t1 is substantially equal to one frame period 1F. In addition, even if the period of time t1 is exactly equal to a period of time obtained by subtracting one horizontal period 1H from one frame period 1F, it may be interpreted that the period of time t1 is substantially equal to one frame period 1F.

The times when the first scan signal is transmitted to the first pixel row block PB1 may be the same as the times when the first scan signal is transmitted to the second pixel row block PB2. For example, the first scan signal may be transmitted simultaneously to the lowest pixel row Rm of first pixel row block PB1 and highest pixel row Rm+1 of second pixel row block PB2. Similarly the first scan signal may be transmitted simultaneously to pixel rows of the same scan ranking in the first pixel row block PB1 and second pixel row block PB2.

When the first scan signal transmitted to the first pixel row block PB1 and the first scan signal transmitted to the second pixel row block PB2 are all selection signals, pixel rows to which the first scan signals are transmitted simultaneously may receive the same data signal. However, when the first scan signals are different (a selection signal and a non-selection signal), even if the first scan signals are transmitted simultaneously to the pixel rows, the pixel rows may receive different data signals.

After receiving the first scan signal, each pixel row realizes an image corresponding to frame image data during one frame period 1F using a received driving signal. A pixel row Rm or Rm+1 which receives the n^{th} frame image data first receives the first scan signal at the same time as when an n^{th} frame begins, and realizes an image corresponding to the n^{th} frame image data until the n^{th} frame ends. Then, when an (n+1)^{th} frame begins, pixel row Rm or Rm+1 realizes an image corresponding to (n+1)^{th} frame image data.

Other pixel rows in each pixel row block (PB1, PB2) sequentially receive the first scan signal with a predetermined time interval between them, after the n^{th} frame begins. Because each pixel row realizes an image corresponding to the n^{th} frame image data during one frame period 1F, the image corresponding to the n^{th} frame image data may be realized until a certain period of time in the (n+1)^{th} frame. This may be accomplished by transcending the boundary of the n^{th} frame. A pixel row R1 or R2m which receives the first scan signal last in each pixel row block (PB1, PB2) may realize most of the image corresponding to the n^{th} frame image data in the (n+1)^{th} frame. For this reason, the image corresponding to the n^{th} frame image data and the image corresponding to the (n+1)^{th} frame image data may be mixed in the (n+1)^{th} frame of the display unit.

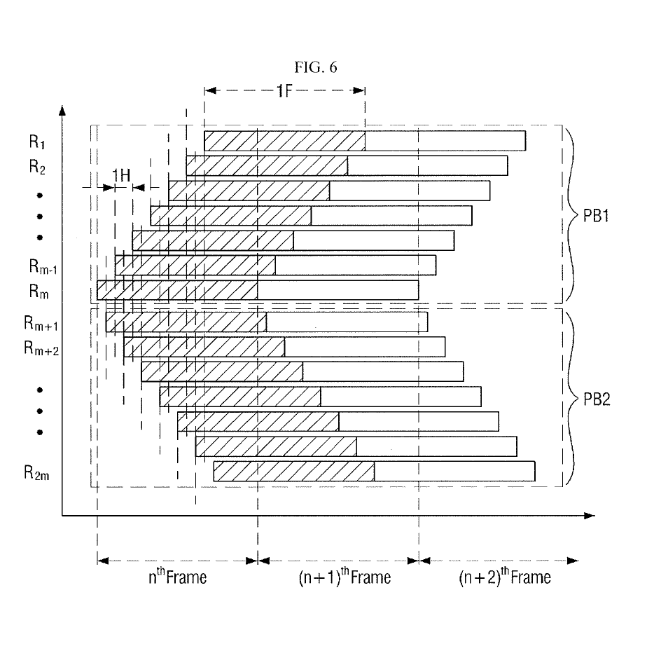

FIG. 6 illustrates a period of time during which a frame image is realized by each pixel row of a display unit according to another embodiment. In FIG. 6, a first scan signal is transmitted to pixel rows of a first pixel row block PB1 and pixel rows of a second pixel row block PB2 at different times.

For example, a first scan signal for reflecting n^{th} frame image data may be transmitted to a lowest row Rm in the first pixel row block PB1. Then, after a predetermined period of time, the first scan signal may be transmitted to a highest row Rm+1 in the second pixel row block PB2. The predetermined period of time may be 1 horizontal period (1H).

After the predetermined period of time (1H), the first scan signal may be transmitted to an adjacent higher row Rm−1 in the first pixel row block PB1. Then, after the predetermined period of time (1H), the first scan signal may be transmitted to an adjacent lower row Rm+2 in the second pixel row block PB2. In the same way, the first scan signal may be transmitted alternately to the first pixel row block PB1 and the second pixel row block PB2.

Unlike the embodiment of FIG. 5, in the embodiment of FIG. 6, the first scan signal is not simultaneously transmitted to a plurality of pixel rows. Accordingly, a different data signal may be transmitted to each pixel row relatively freely.

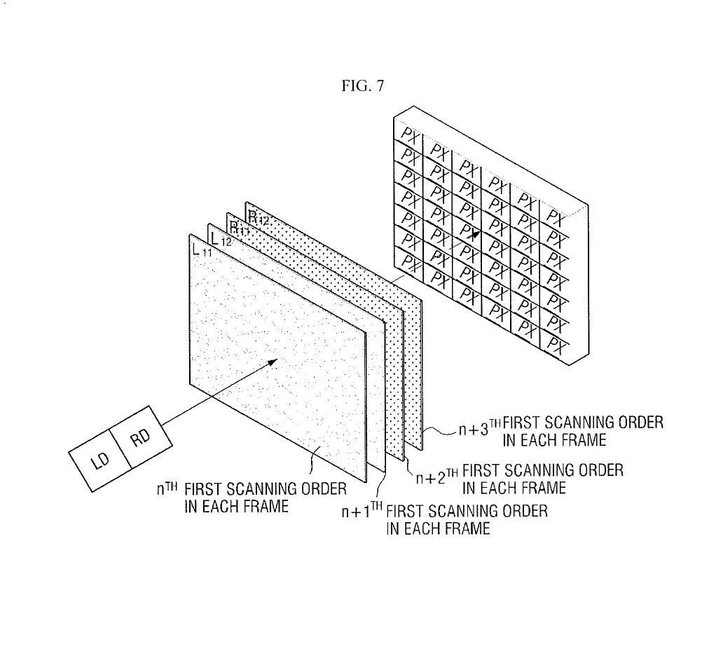

FIG. 7 illustrates frame image data of a driving unit according to one embodiment. Referring to FIG. 7, the driving unit may sequentially receive first image data LD that forms one frame and second image data RD that forms another adjacent frame. The first and second image data LD and RD may be received from an image source. Based on the first image data LD and second image data RD, the driving unit may provide first frame image data L1 and second frame image data R1 (or signals based on the first frame image data L1 and second frame image data R1) to a display unit multiple times.

For example, the driving unit may receive the first image data LD and generate the first frame image data L1. In addition, the driving unit may receive the second image data RD and generate the second frame image data R1. The driving unit may provide the first frame image data L1 (e.g. L11) in an n^{th} frame, and may provide the first frame image data L1 (e.g., L12) again in a subsequent (n+1)^{th} frame. Then, the driving unit may provide the second frame image data R1 (e.g., R11) in an (n+2)^{th} frame, and may provide the second frame image data R1 (e.g., R12) again in a subsequent (n+3)^{th} frame.

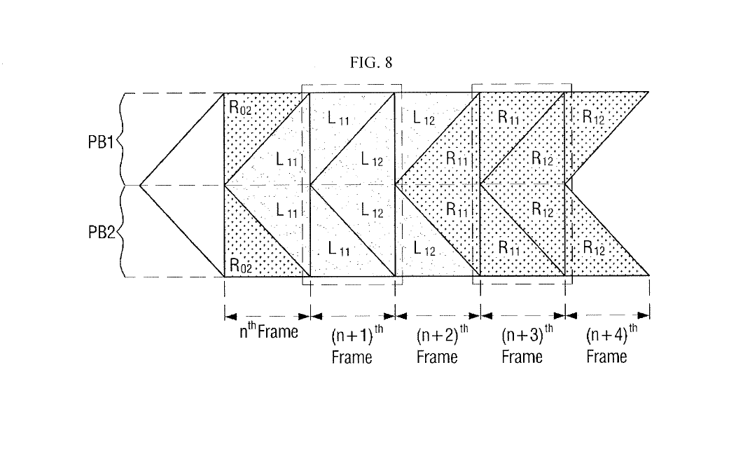

FIG. 8 illustrates a pattern in which frame image data may be input to each pixel row with respect to time according to another embodiment. Referring to FIG. 8, in an n^{th} frame, the first frame image data L11 is sequentially input for the first time to pixels of each pixel row block (PB1, PB2).

For the first pixel row block PB1, the first frame image data L11 is input for the first time to a lowest row when the n^{th} frame begins, and then is input for the first time to an adjacent higher row. The first frame image data L11 is last input for the first time to a highest row of the first pixel row block PB1 when the n^{th} frame almost ends.

For the second pixel row block PB2, first frame image data L11 is input for the first time to a highest row when the n^{th} frame begins, and then is input for the first time to an adjacent lower row. The first frame image data L11 is last input for the first time to a lowest row of the second pixel row block PB2 when the n^{th} frame almost ends. (R02 indicates previous frame image data input for the second time).

In an (n+1)^{th} frame, the first frame image data L12 is sequentially input for the second time to the pixels of each pixel row block (PB1, PB2). The order in which first frame image data L12 is input for the second time within each pixel row block (PB1, PB2) in the (n+1)^{th} frame is identical to the order in which the first frame image data L11 is input for the first time within each pixel row block (PB1, PB2) in the nth frame.

Likewise, the second frame image data RH is sequentially input for the first time to the pixels of each pixel row block (PB1, PB2) in an (n+2)^{th} frame. The second frame image data R12 is sequentially input for the second time to the pixels of each pixel row block (PB1, PB2) in an (n+3)^{th} frame. In the same way, the same frame image data may be repeatedly input to the pixels of each pixel block (PB1, PB2) in every two subsequent frames.

The overall frame data input pattern is a divergence pattern. For example, when a frame begins, frame data is input to rows in the center of the display unit. Then, the frame data is sequentially input to rows located gradually away from the center of the display unit. When the frame is about to end, the frame data is finally input to rows located in upper and lower ends of the display unit.

In the current embodiment, different images are mixed in the n^{th} frame and the (n+2)^{th} frame. The previous frame image data RO2 and the first frame image data L11 are mixed in the n^{th} frame. The first frame image data L12 and the second frame image data R11 are mixed in the (n+2)^{th} frame. On the other hand, only the first frame image data L11 and L12 (L11 and L12 are the same frame image data) is input during the entire (n+1)^{th} frame. Also, only the second frame image data R11 and R12 (R11 and R12 are the same frame image data) is input during the entire (n+3)^{th} frame.

Thus, frames may be divided into frames in which single frame image data is input and frames in which a number of images are mixed. In other words, an unmixed image and a mixed image may be input alternately in each frame.

In one embodiment, a display device may extract an unmixed image or a mixed image independently by performing different processing in each frame. For example, in the n^{th} and (n+2)^{th} frames in which an unmixed image is input, the display device may realize an image corresponding to input image frame data through normal pixel driving. In the (n+1)^{th} frame and the (n+3)^{th} frame in which a mixed image is input, the display device may prevent the realization of an image corresponding to input image frame data by blocking light emission by changing a driving signal or by blocking emitted light.

Accordingly, a viewer may recognize an unmixed image only. In this case, the viewer may recognize an unmixed image with a frequency corresponding to half of an actual driving frequency. For example, if a frame driving frequency is 240 Hz, the viewer may recognize an unmixed image corresponding to 120 Hz. If the frame driving frequency is 120 Hz, the viewer may recognize an unmixed image corresponding to 60 Hz.

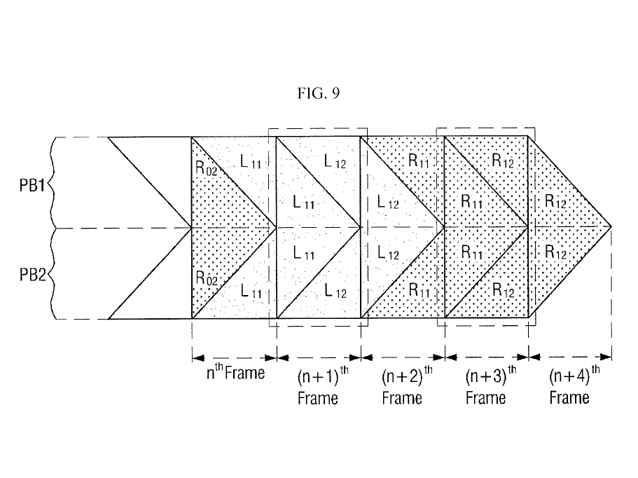

FIGS. 9 through 15 illustrate patterns in which frame image data is input to each pixel row with respect to time according to additional embodiments.

The embodiment of FIG. 9 is different from the embodiment of FIG. 8 in terms of the scanning order of each pixel row block. For example, the scanning order of first pixel row block PB1 may be a downward direction from a highest row of the first pixel row block PB1. The scanning order of a second pixel row block PB2 may be an upward direction from a lowest row of second pixel row block PB2. Thus, the overall frame data input pattern is a convergence pattern.

For example, when a frame begins, frame data is input to rows located in upper and lower ends of a display unit. Then, the frame data is sequentially input to rows located gradually toward the center of the display unit. When the frame is about to end, the frame data is finally input to rows located in the center of the display unit.

In the current embodiment, different images are mixed in the n^{th} frame and (n+2)^{th} frame, and only a single image is input in the (n+1)^{th} frame and the (n+3)^{th} frame. Because an unmixed image and mixed image are input alternately in each frame, only the unmixed image or the mixed image may be extracted independently through different processing in each frame.

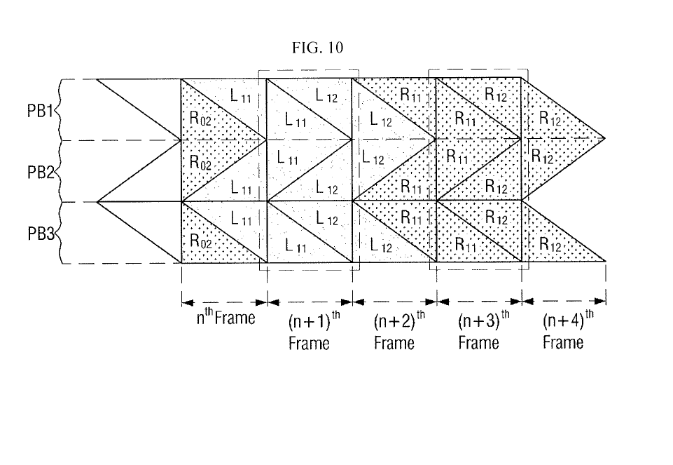

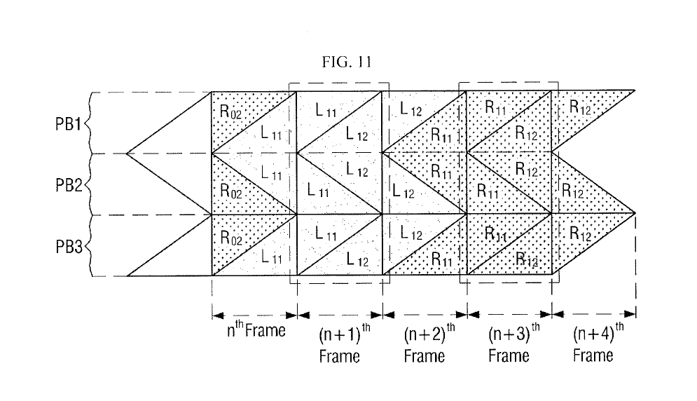

In the embodiments of FIGS. 10 and 11, three pixel row blocks (PB1, PB2, PB3) are provided, where the pixel row blocks have an equal number of pixel rows.

In the embodiment of FIG. 10, the scanning order of the first pixel row block PB1 is a downward direction from a highest row of the first pixel row block PB1. The scanning order of the second pixel row block PB2 is an upward direction from a lowest row of the second pixel row block PB2. The scanning order of the third pixel row block PB3 is a downward direction from a highest row of the third pixel row block PB3.

In the embodiment of FIG. 11, the scanning order of first pixel row block PB1 is an upward direction from a lowest row of first pixel row block PB1. The scanning order of second pixel row block PB2 is a downward direction from a highest row of second pixel row block PB2. The scanning order of third pixel row block PB3 is an upward direction from a lowest row of third pixel row block PB3.

A scan driver of the display device may include a scan driving unit that matches each pixel row block. For example, the scan driver may include a first scan driving unit that matches the first pixel row block PB1, a second scan driving unit that matches the second pixel row block PB2, and a third scan driving unit that matches third pixel row block PB3.

In the embodiments of FIGS. 10 and 11, different images are mixed in the n^{th} frame and (n+2)^{th} frame. Only a single image is input in the (n+1)^{th} frame and (n+3)^{th} frame. Because an unmixed image and mixed image are input alternately in each frame, only the unmixed image or the mixed image may be extracted independently through different processing in each frame.

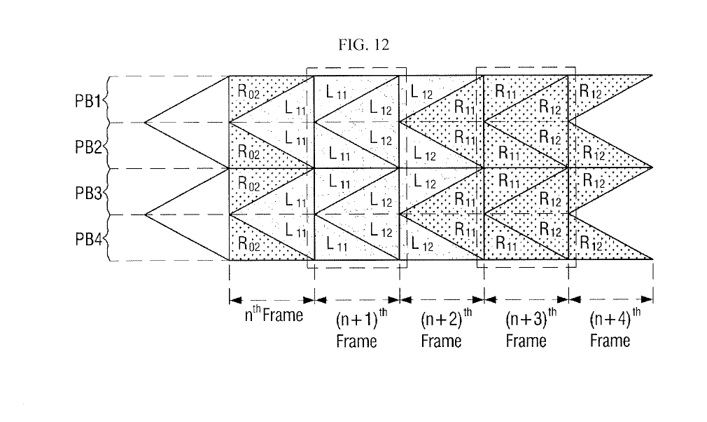

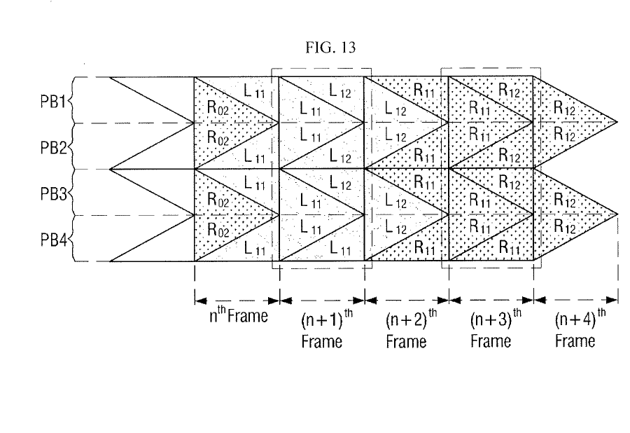

In the embodiments of FIGS. 12 and 13, four pixel row blocks (PB1, PB2, PB3, PB4) are provided, where the pixel row blocks have an equal number of pixel rows.

In the embodiment of FIG. 12, the scanning order of first pixel row block PB1 is a downward direction from a highest row of first pixel row block PB1. The scanning order of second pixel row block PB2 is an upward direction from a lowest row of second pixel row block PB2. The scanning order of third pixel row block PB3 is a downward direction from a highest row of third pixel row block PB3. The scanning order of fourth pixel row block PB4 is an upward direction from a lowest row of fourth pixel row block PB4.

In the embodiment of FIG. 13, the scanning order of the first pixel row block PB1 is an upward direction from a lowest row of first pixel row block PB1. The scanning order of the second pixel row block PB2 is a downward direction from a highest row of the second pixel row block PB2. The scanning order of the third pixel row block PB3 is an upward direction from a lowest row of the third pixel row block PB3. The scanning order of fourth pixel row block PB4 is a downward direction from a highest row of fourth pixel row block PB4.

The scan driver of a display device may include a first scan driving unit that matches the first pixel row block PB1, a second scan driving unit that matches the second pixel row block PB2, a third scan driving unit that matches the third pixel row block PB3, and a fourth scan driving unit that matches the fourth pixel row block PB4.

In the embodiments of FIGS. 12 and 13, different images are mixed in the n^{th} frame and (n+2)^{th} frame. Only a single image is input in the (n+1)^{th} frame and the (n+3)^{th} frame. Because an unmixed image and a mixed image are input alternately in each frame, only the unmixed image or the mixed image may be extracted independently through different processing in each frame.

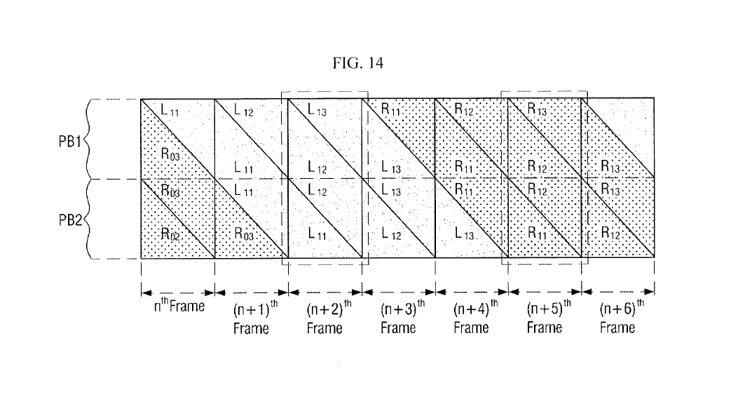

In the embodiment of FIG. 14, the scanning order of the first pixel row block PB1 is the same as a scanning order of the second pixel row block PB2. For example, the scanning order of the first pixel row block PB1 is a downward direction from a highest row of the first pixel row block PB1. The scanning order of the second pixel row block PB2 is a upward direction from a lowest row of the second pixel row block PB2. In other words, the overall frame data input pattern is: a pattern in which frame data is input to rows located in an upper end and a center of a display unit when a frame begins, then sequentially input to rows located gradually downward from the upper end and center of the display unit, and finally input to rows located in the center and a lower end of the display unit when the frame is about to end.

In the current embodiment, a driving unit receives first image data and second image data, generates first frame image data and second frame image data, and provides the first frame image data and second frame image data to each pixel three times.

For example, in an n^{th} frame, the first frame image data L11 is input for the first time to a highest row of the first pixel row block PB1 when the n^{th} frame begins, and then is input for the first time to an adjacent lower row. The previous frame image data R03 is input for the third time to a highest row of the second pixel row block PB2 when the n^{th} frame begins, and then is input for the third time to an adjacent lower row. (R02 indicates previous frame image data input for the second time).

In the same way, in an (n+1)^{th} frame, the first frame image data L12 is input for the second time to the first pixel row block PB1. The first frame image data L11 is input for the first time to the second pixel row block PB2. In the (n+2)^{th} frame, the first frame image data L13 is input for the third time to the first pixel row block PB1, and the first frame image data L12 is input for the second time to the second pixel row block PB2.

In the (n+3)^{th} frame, the second frame image data R11 is input for the first time to the first pixel row block PB1. The first frame image data L13 is input for the third time to the second pixel row block PB2.

In the same way, in the (n+4)^{th} frame, the second frame image data R12 is input for the second time to the first pixel row block PB1. The second frame image data R11 is input for the first time to the second pixel row block PB2. In the (n+5)^{th} frame, the second frame image data R13 is input for the third time to first pixel row block PB1, and the second frame image data R12 is input for the second time to the second pixel row block PB2.

In the current embodiment, different images are mixed in the n^{th} frame, the (n+1)^{th} frame, the (n+3)^{th} frame, and the (n+4)^{th} frame. On the other hand, only the first frame image data L11, L12 and L13 is input during the entire (n+2)^{th} frame, and only the second frame image data R11, R12 and R13 is input during the entire (n+5)^{th} frame. For example, in the current embodiment, an unmixed image is input in every third frame. Therefore, only an unmixed image or a mixed image may be extracted independently through different processing in each frame.

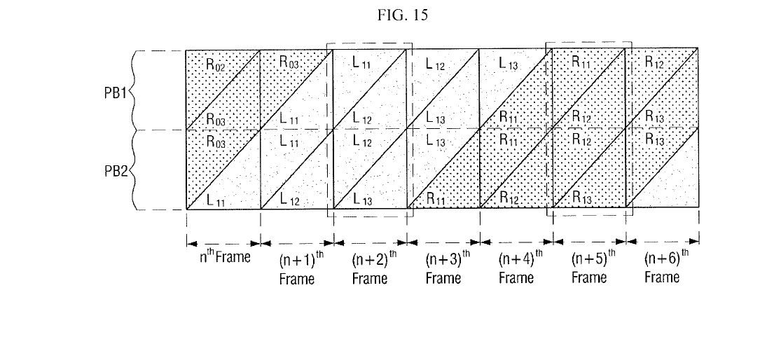

The embodiment of FIG. 15 is different from the embodiment of FIG. 14 in the scanning order of each pixel row block. For example, the scanning order of first pixel row block PB1 and the scanning order of second pixel row block PB2 are an upward direction from a lowest row. In other words, the overall frame data input pattern is: a pattern in which frame image data is input to rows located in a lower end and a center of a display unit when a frame begins, then sequentially input to rows located gradually upward from the lower end and center of the display unit, and finally input to rows located in the center and an upper end of the display unit when the frame is about to end.

In the current embodiment, different images are mixed in an (n+1)^{th} frame, an (n+3)^{th} frame, and an (n+4)^{th} frame. On the other hand, only first frame image data is input during the entire (n+2)^{th} frame, and only second frame image data is input during the entire (n+5)^{th} frame. Thus, in the current embodiment, an unmixed image is input in every third frame. Therefore, only an unmixed image or a mixed image may be extracted independently through different processing in each frame.

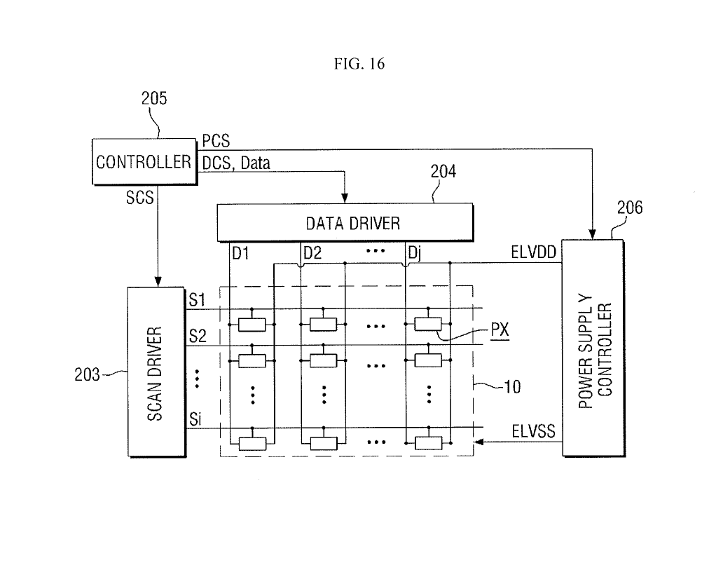

FIG. 16 illustrates an embodiment of a display device 101 which includes a display unit and a driving unit. The display unit includes a plurality of scan lines S1 through Si and a plurality of pixels PX connected to a plurality of data lines D1 through Dj. Each of the pixels PX includes an organic light-emitting diode (OLED) as a light-emitting element.

The driving unit includes a scan driver 203, a data driver 204, a power supply controller 206, and a controller 205. The scan driver 203 supplies scan signals to scan lines S1 through Si. The data driver 204 supplies data signals to data lines D1 through Dj. The power supply controller 206 is connected to and supplies power to the display unit. The controller 205 controls the scan driver 203, data driver 204, and power supply controller 206.

The controller 205 generates a data driving control signal DCS, a scan driving control signal SCS, and a power supply control signal PCS in response to synchronization signals from an external source. The data driving control signal DCS may be supplied to data driver 204. The scan driving control signal SCS may be supplied to scan driver 203. The power supply control signal PCS may be provided to power supply controller 206. The controller 205 may convert image data received from an external source to a data signal Data corresponding to frame image data, and may supply the data signal Data to data driver 204.

The power supply controller 206 may control the power supply of a first power source ELVDD and a second power source ELVSS, which supply driving voltages to the display unit based on a power supply control signal PCS from controller 205.

The first power source ELVDD and second power source ELVSS may supply two driving voltages to operate the pixels PX. For example, the first power source ELVDD may supply a first driving voltage, and the second power source ELVSS may supply a second driving voltage. The power supply control signal PCS may control a voltage level of the first driving voltage and a voltage level of the second driving voltage.

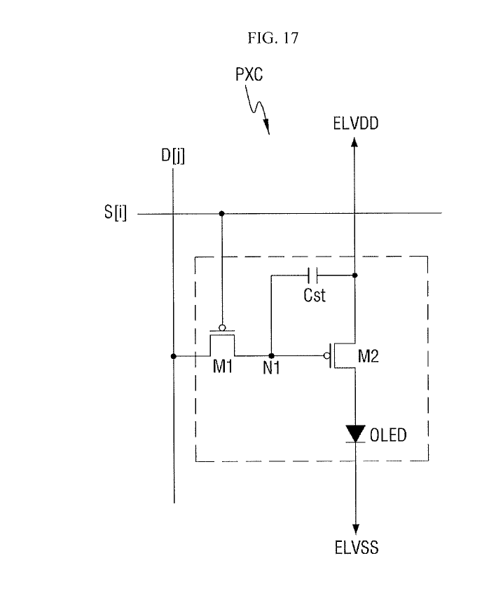

FIG. 17 illustrates one embodiment of a pixel, which may correspond to pixels PX in FIG. 16. Referring to FIG. 17, the pixel includes a pixel circuit PXC having a first transistor M1, a second transistor M2, a storage capacitor Cst, and an organic light-emitting diode (OLED).

The first transistor M1 has a gate electrode connected to a scan line S[i], a source electrode connected to a data line D[j], and a drain electrode connected to a first node N1. The first transistor M1 may deliver a data signal flowing through data line D[j] to first node N1 in response to a scan signal received through scan line S[i].

The second transistor M2 has a gate electrode connected to first node N1, a source electrode connected to first power source ELVDD, and a drain electrode connected to a first electrode of the OLED. The second transistor M2 may allow a driving current to flow in a direction from the source electrode to the drain electrode thereof in response to a voltage applied to first node N1. The first transistor M1 may be a switching transistor, and the second transistor M2 may be a driving transistor.

The storage capacitor Cst has a first end connected to first power source ELVDD, and a second end connected to the source electrode of second transistor M2. The storage capacitor Cst may maintain a voltage difference between the gate electrode and the source electrode of the second transistor M2 for a certain period of time.

The OLED has the first electrode (e.g., anode) connected to the drain electrode of second transistor M2 and a second electrode (e.g., cathode) connected to second power source ELVSS.

The OLED may or may not emit light based on a difference between a level of a voltage applied to the first electrode and a level of a voltage applied to the second electrode. Specifically, when receiving a first driving voltage at a high level from first power source ELVDD and a second driving voltage at a low level from second power source ELVSS, the OLED may emit light based on a driving current corresponding to an image data signal.

On the other hand, when receiving the first driving voltage at a high level from first power source ELVDD and second driving voltage at a high level from second power source ELVSS connected to the second electrode, the OLED may not emit light because the driving current cannot flow. Accordingly, an image may not be realized. For example, the second driving voltage at a low level is an emission signal for the OLED. The second driving voltage at a high level is a non-emission signal for the OLED.

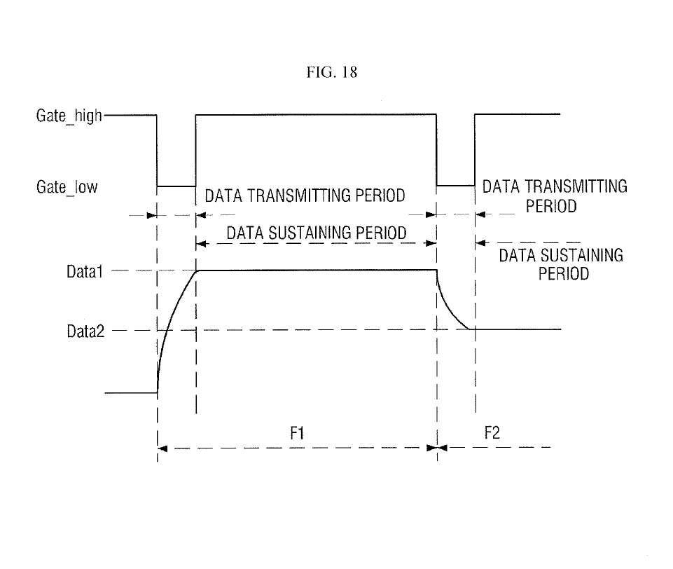

FIG. 18 is a waveform diagram illustrating one embodiment of a pixel driving method. Referring to FIGS. 17 and 18, in a frame F1, when a selection signal Gate_low is transmitted to scan line S[i], first transistor M1 is turned on. Also, a first data signal Datal from data line D[j] is delivered to first node N1 and gate electrode of second transistor M2, connected to first node N1 via first transistor M1 (a data transmitting period).

Then, when a non-selection signal Gate_high is transmitted to scan line S[i], first transistor M1 is turned off. The voltage at first node N1 and the gate electrode of second transistor M2 connected to first node N1 is sustained by storage capacitor Cst (a data sustaining period). The data sustaining period may continue until the selection signal Gate_low is transmitted to scan line S[i] in a next frame F2.

In next frame F2, selection signal Gate_low is transmitted again to scan line S[i], to turn on first transistor M1. In addition, the voltage at first node N1 and the gate electrode of second transistor M2 changes to a second data signal Data2 delivered from data line D[j]. When non-selection signal Gate_high is transmitted to scan line S[i], the data sustaining period begins.

In the current embodiment, the selection signal (Gate_low) transmitting period or data transmitting period may be substantially equal to one horizontal period. The non-selection signal (Gate_high) transmitting period or data sustaining period may be a period obtained by subtracting one horizontal period from one frame.

Even when a certain data voltage is applied to first node N1 and the gate electrode of second transistor M2, connected to first node N1, the magnitude of driving current flowing through the OLED may be controlled by other factors.

For example, when a first driving voltage is at a high level and when a second driving voltage is at a low level, the voltage difference between the gate electrode and source electrode of second transistor M2 is a difference between a voltage corresponding to a data signal and the first driving voltage of first power source ELVDD. Accordingly, the driving current corresponding to the voltage difference may flow through second transistor M2. The driving current may be delivered to the OLED, and the OLED may emit light according to the received driving current.

When the first driving voltage is at a high level and when the second driving voltage is at a high level or off, the driving current may not flow through the OLED. Accordingly, the OLED may not emit light.

In this regard, the light emission or non-light emission of the OLED may be controlled by controlling second power source ELVSS to provide the second driving voltage at a low or high level or to turn the second driving voltage off. The voltage of the second power source ELVSS may be controlled by power supply control signal PCS, as described above.

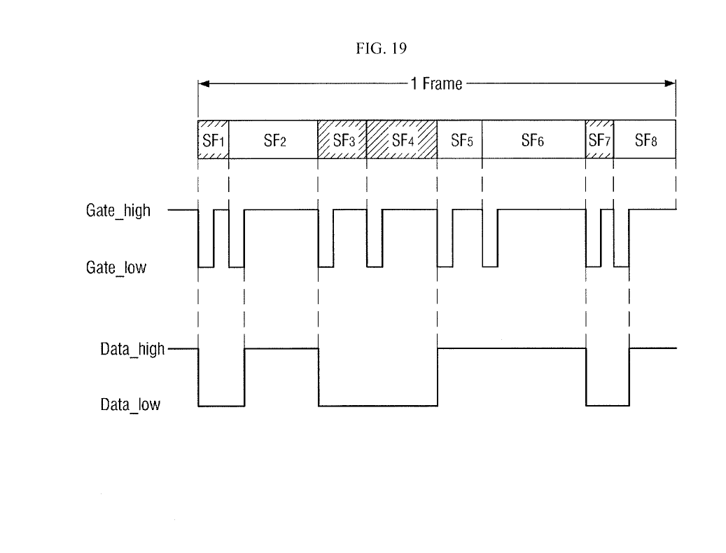

FIG. 19 is a waveform diagram illustrating a second embodiment of a pixel driving method. Referring to FIGS. 17 and 19, in the current embodiment, one frame of each pixel includes a plurality of subframes. Also, in the current embodiment, one frame includes eight subframes SF1 through SF8. In other embodiments, the frame may include a different number of subframes. At least some of the subframes SF1 through SF8 may have different time lengths. Alternatively, all of the subframes SF1 through SF8 may have different time lengths.

A plurality of pixels in the same row may have the same combination of subframes SF1 through SF8. (A combination of subframes SF1 through SF8 may denote a combination of first through eighth subframes SF1 through SF8 arranged in this order within one frame). Pixels in different pixel rows may have different combinations of subframes SF1 through SF8.

In each of the subframes SF1 through SF8, a selection signal Gate_low is transmitted to scan line S[i] of a corresponding pixel. When one frame includes eight subframes SF1 through SF8, the selection signal Gate_low may therefore be transmitted at least eight times to scan line S[i] within one frame. In each of the subframes SF1 through SF8, the selection signal Gate_low may be transmitted for an equal period of time. The selection signal transmitting period may be smaller than or equal to a minimum period of each of the subframes SF1 through SF8. The selection signal Gate_low and a non-selection signal Gate_high may be transmitted once in each of the subframes SF1 through SF8.

The selection signal transmitting periods of subframes in different rows may not overlap each other. If the selection signal transmitting periods do not overlap each other, data signal Data may be transmitted only to a specific row at a specific time.

Each of the subframes SF1 through SF8 has a data transmitting period and a data sustaining period similar to those of the frame F1 of FIG. 18. However, a length of the data sustaining period may be limited to a width of each of the subframes SF1 through SF8.

In a subframe, when selection signal Gate_low is transmitted to scan line S[i], the first transistor M1 is turned on. A data signal from data line D[j] is delivered to the first node N1 and the gate electrode of the second transistor M2 via the first transistor M1. In one embodiment, the data signal may be a digital signal, e.g., the data signal may be a signal that swings between a data signal Data_high at a high level and a data signal Data_low at a low level.

The light emission of the OLED may be affected by whether the data signal is at a high level or a low level. For example, when a first driving voltage is at a high level and when a second driving voltage is at a low level, the OLED may not emit light in response to the data signal Data_high at a high level and may emit light in response to the data signal Data_low at a low level. When the second transistor M2 is not a PMOS transistor (as in FIG. 17) but is an NMOS transistor, the OLED may emit light in response to the data signal Data_high at a high level and may not emit light in response to the data signal Data_low at a low level.

Whether each of the subframes SF1 through SF8 will emit light may be determined by a data signal. The luminance of a pixel may be determined by a total period of time during which the pixel emits light within one frame, e.g., the sum of light-emitting subframe periods.

As described above with reference to FIGS. 17 and 18, when the second power source ELVSS is controlled to provide the second driving voltage at a low level or a high level or to turn the second driving voltage off, the OLED may not emit light regardless of the level of a data signal and the combination of subframes.

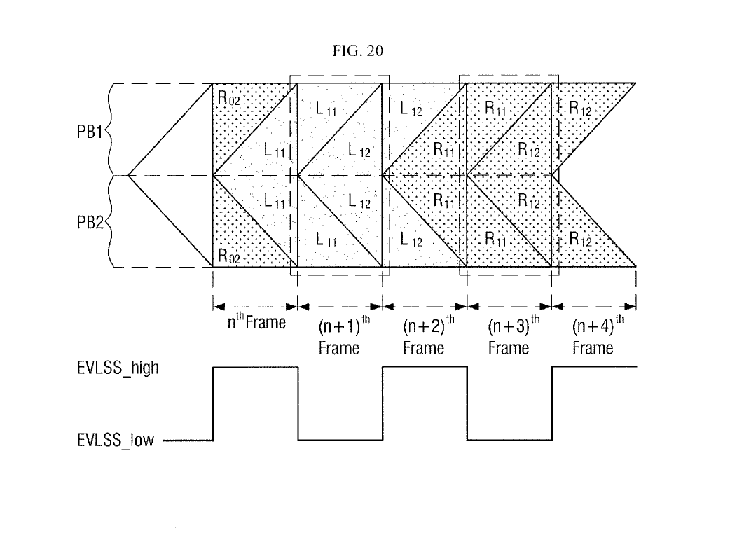

FIG. 20 is a driving waveform diagram of a display device in each frame according to another embodiment. FIG. 20 illustrates an exemplary method of controlling the light emission of an OLED when frame image data is input to each pixel row in the pattern according to the embodiment of FIG. 8.

In this embodiment, a first power source ELVDD supplies a first driving voltage at a high level regardless of frames. On the other hand, a second power source ELVSS supplies a second driving voltage ELVSS_high at a high level and a second driving voltage ELVSS_low at a low level alternately in each frame as in FIG. 20.

In FIG. 8, an n^{th} frame is a mixed image frame in which previous frame image data R02 and first frame image data L11 are mixed. A subsequent (n+1)^{th} frame is an unmixed image frame in which only the first frame image data L11 and L12 is input. In addition, an (n+2)^{th} frame is a mixed image frame in which the first frame image data L12 and second frame image data R11 are mixed. An (n+3)^{th} frame is an unmixed image frame in which only the second frame image data R11 and R12 is input.

The second power source EVLSS may apply the second driving voltage ELVSS_high at a high level to a display unit in mixed image frames, and may apply the second driving voltage ELVSS_low at a low level to the display unit in unmixed image frames. Accordingly, the OLED of each pixel may not emit light in the mixed image frames regardless of a data signal input to each pixel. On the other hand, in the unmixed image frames, the amount of light emission of the OLED of each pixel may be controlled by the data signal input to each pixel. Thus, corresponding luminance may be realized. In this regard, the display device may not realize a mixed image as an image and may realize only an unmixed image as an image.

To drive the display device as described above, the second driving voltage swings between a high level ELVSS_high and low level ELVSS_low in synchronization with the initiation of each frame. The second driving voltage is inverted at the same time when frames are changed. Therefore, the second driving voltage may swing in synchronization of a clock signal for notifying initiation of each frame. Accordingly, the second driving voltage ELVSS_high at a high level and second driving voltage ELVSS_low at a low level may be applied simply and accurately to the display unit without complicated logic.

In the same way, when frame image data is input to each pixel row in the pattern in FIG. 14 or FIG. 15, the second driving voltage ELVSS_high at a high level may be applied in the n^{th} frame and the (n+1)^{th} frame, and the second driving voltage EVLSS_low at a low level may be applied in the (n+2)^{th} frame. In addition, the second driving voltage EVLSS_high at a high level may be applied in the (n+3)^{th} frame and an (n+4)^{th} frame, and the second driving voltage EVLSS_low at a low level may be applied in an (n+5)^{th} frame.

The display devices according to the various embodiments described herein may be applied to 3D image display devices. A 3D image display device may display a 3D image using binocular disparity. To display a 3D image, a left-eye image and a right-eye image corresponding respectively to different points of view of both eyes are displayed sequentially. To make a viewer recognize a 3D image by delivering the left-eye and right-eye images to both eyes at different times, liquid crystal shutter glasses may be used.

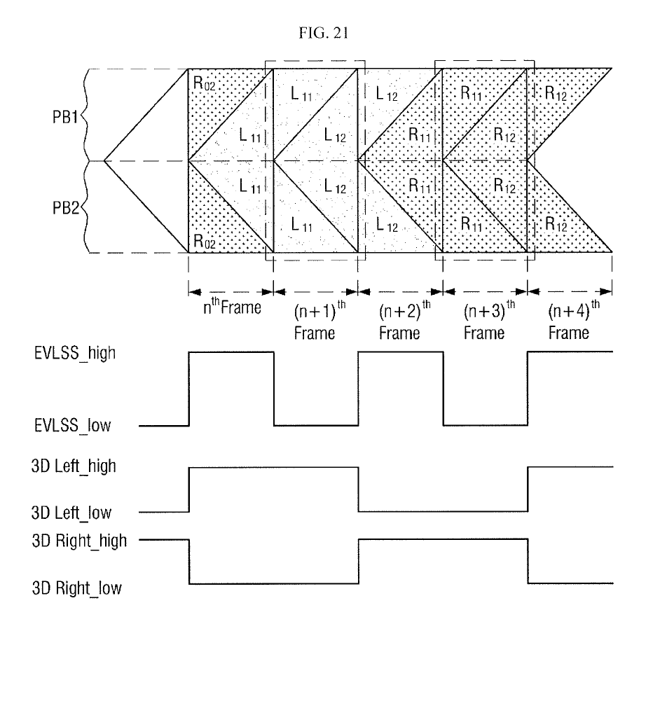

FIG. 21 is a driving waveform diagram of a display device in each frame according to another embodiment. Referring to FIG. 21, first frame image data L11 or L12 may correspond to a left-eye image, and second frame image data R11 or RI 2 may correspond to a right-eye image. As described for the embodiment in FIG. 20, the display device may realize an image in the (n+1)^{th} frame in which only the left-eye image is displayed and the (n+3)^{th} frame in which only the right-eye image is displayed. On the other hand, because light emission itself is blocked in the nth frame and (n+2)^{th} frame in which the left-eye and right-eye images are mixed, no image is realized. Therefore, it is possible to prevent crosstalk due to mixing of the left-eye and right-eye images.

In a lower part of FIG. 21, driving signals transmitted to shutter glasses are illustrated. A left-eye shutter and a right-eye shutter open in response to a driving signal at a high level, to thereby transmit light. In addition, the left-eye shutter and right-eye shutter close in response to a driving signal at a low level, to thereby block light.

The driving signal at a high level is transmitted to the left-eye shutter in synchronization with a start time of the n^{th} frame, and is maintained for two frames from the nth frame to the (n+1)^{th} frame. In addition, the driving signal at a high level is inverted to the driving signal at a low level in synchronization with a start time of the (n+2)^{th} frame, and is maintained for two frames from the (n+2)^{th} frame to the (n+3)^{th} frame.

The driving signal at a low level is transmitted to the right-eye shutter in synchronization with the start time of the n^{th} frame, and is maintained for two frames from the n^{th} frame to the (n+1)^{th} frame. In addition, the driving signal at a low level is inverted to the driving signal at a high level in synchronization with the start time of the (n+2)^{th} frame, and is maintained for two frames from the (n+2)^{th} frame to the (n+3)^{th} frame.

In the current embodiment, during the n^{th} frame and the (n+1)^{th} frame, the left-eye shutter is open and the right-eye shutter is closed. During the (n+2)^{th} frame and (n+3)^{th} frame, the right-eye shutter is open and the left-eye shutter is closed. Because only the left-eye image is realized on the display device during the n^{th} frame and (n+1)^{th} frame, a viewer may recognize the left-eye image only through the left-eye shutter. On the other hand, because only the right-eye image is realized on the display device during the (n+2)^{th} frame and (n+3)^{th} frame, the viewer may recognize only the right-eye image through the right-eye shutter.

Unlike the waveforms of the driving signals in FIG. 21, response waveforms of the shutters may be delayed for a certain period of time. For example, when the driving signal at a high level is transmitted to the left-eye shutter at the start time of the n^{th} frame, the left-eye shutter may not fully open immediately. Instead, the left-eye shutter may open gradually for a certain period of time. In addition, when the driving signal at a low level is transmitted to the right-eye shutter, the right-eye shutter may not completely close immediately. Instead, the right-eye shutter may close gradually for a certain period of time.

Because the left-eye shutter does not fully open immediately after receiving a driving signal in the n^{th} frame due to a delay in its response speed, a full image provided by a display may not pass through the left-eye shutter. In addition, because the right-eye shutter does not completely close immediately after receiving a driving signal in the n^{th} frame due to a delay in its response speed, an image provided by the display may pass through the right-eye shutter.

However, in the current embodiment, because the second driving voltage ELVSS_high at a high level is provided in the n^{th} frame, light emission is prevented at source. Therefore, even if the shutters open or close incompletely for a certain period of time, a viewer may recognize an image without being substantially affected by the incomplete opening or closing of the shutters. In this regard, the display device according to the current embodiment may provide a 3D image with reduced crosstalk that a viewer may watch without using relatively expensive high-speed shutter glasses.

In accordance with one or more of the aforementioned embodiments, a display device and method are provided which selectively display a mixed image frame and an unmixed image frame.

In accordance with these or other embodiments, a display device may retain both a mixed image frame and an unmixed image frame and display any one of the mixed image frame and unmixed image frame. Therefore, the display device may display an optimum image suitable for various purposes. Furthermore, if applied to a 3D image display device, the display device may prevent crosstalk between a left-eye and right-eye images. Therefore, the quality of the 3D image display device may be improved.

The methods and processes described herein may be performed by code or instructions to be executed by a computer, processor, or controller. Because the algorithms that form the basis of the methods are described in detail, the code or instructions for implementing the operations of the method embodiments may transform the computer, processor, or controller into a special-purpose processor for performing the methods described herein.

Also, another embodiment may include a computer-readable medium, e.g., a nontransitory computer-readable medium, for storing the code or instructions described above. The computer-readable medium may be a volatile or non-volatile memory or other storage device, which may be removably or fixedly coupled to the computer, processor, or controller which is to execute the code or instructions for performing the method embodiments described herein.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A display device, comprising:
a display unit including a plurality of pixels arranged in a matrix, the matrix including a first pixel row block and a second pixel row block;
a scan driver unit including a first scan driver to sequentially transmit a first scan signal in each frame to the first pixel row block and a second scan driver to sequentially transmit the first scan signal in each frame to the second pixel row block; and
a data driver to input first frame image data for a first time to the display unit in an n-th frame and to input the first frame image data for a second time to the display unit in an (n+1)-th frame.

2. The display device as claimed in claim 1, wherein the first frame image data is input to each of the pixels for one frame period, after the first scan signal in each frame is transmitted to each of the pixels.

3. The display device as claimed in claim 1, wherein a number of the pixel rows in the first pixel row block is equal to a number of the pixel rows in the second pixel row block.

4. The display device as claimed in claim 1, wherein a period of time, from when the first scan signal in each frame is transmitted first to each pixel row block to when the first scan signal in each frame is transmitted last to each pixel row block, is substantially equal to one frame period.

5. The display device as claimed in claim 1, wherein:
the second pixel row block is directly below the first pixel row block,
the first scan signal in each frame is sequentially transmitted along a first direction in the first pixel row block, and
the first scan signal in each frame is sequentially transmitted along a second direction, which is opposite to the first direction, in the second pixel row block.

6. The display device as claimed in claim 5, wherein the data driver:
inputs second frame image data for a first time to the display unit in an (n+2)-th frame, and
inputs a second frame image data for a second time to the display unit in an (n+3)-th frame.

7. The display device as claimed in claim 6, wherein:
the (n+1)-th frame is an unmixed image frame in which only a first frame image data is input, and
the (n+2)-th frame is a mixed image frame in which the first frame image data and second frame image data are input together.

8. The display device as claimed in claim 7, wherein each of the pixels includes a light-emitting element which does not emit light in the unmixed image frame.

9. The display device as claimed in claim 8, further comprising:
a driving unit including a first power source to supply a first driving voltage and a second power source to supply a second driving voltage,
wherein the second power source causes the light-emitting element to emit light according to input frame image data by supplying the second driving voltage at a first level during the unmixed image frame, and causes the light-emitting element to not emit light regardless of the input frame image data by supplying the second driving voltage at a second level during the mixed image frame.

10. The display device as claimed in claim 6, wherein the first frame image data is left-eye image data and the second frame image data is right-eye image data.

11. The display device as claimed in claim 1, wherein:
the second pixel row block is directly below the first pixel row block, and
a direction in which the first scan signal in each frame is transmitted sequentially to the first pixel row block is equal to a direction in which the first scan signal in each frame is transmitted sequentially to the second pixel row block.

12. The display device as claimed in claim 11, wherein the data driver:
inputs first frame image data for a third time to the display unit in the (n+2)-th frame,
inputs second frame image data for a first time to the display unit in the (n+3)-th frame,
inputs the second frame image data for a second time to the display unit in an (n+4)-th frame, and
inputs the second frame image data for a third time to the display unit in an (n+5)-th frame.

13. The display device as claimed in claim 1, wherein the first frame image data is input to each of the pixels for one frame period, after the first scan signal in each frame is transmitted to each of the pixels.

14. The display device as claimed in claim 1, wherein the first scan driver and the second scan driver are located on separate driver integrated circuit (IC) chips.

15. The display device as claimed in claim 1, wherein:
the first scan signal in each frame is transmitted alternately to each pixel row of the first pixel row block and each pixel row of the second pixel row block, and
the first scan signal in each frame is transmitted to the first pixel row block and the second pixel row block at different times.

16. The display device as claimed in claim 1, wherein each of the first frame image data and the second frame image data includes a plurality of subframe data.

17. A display device, comprising:
a display unit including a plurality of pixels arranged in a matrix, the matrix including a plurality of pixel row blocks; and
a driving unit to provide a driving signal to the display unit, wherein the driving unit sequentially scans each of the pixel row blocks and provides same frame image data to the display unit for two or more successive frames.

18. The display device as claimed in claim 17, wherein the driving signal includes a blocking signal to block display of the display unit for at least one of the two or more successive frames.

19. A method of driving a display device, the method comprising:
generating first frame image data based on image data from an image source;
sequentially inputting the first frame image data for a first time to each of a plurality of pixel blocks of the display device, while transmitting a non-emission driving signal to each pixel of the display device during a first frame; and
inputting the first frame image data for a second time to the pixels of each pixel block of the display device, while transmitting an emission driving signal to each pixel of the display device during a second frame following the first frame.

20. The method as claimed in claim 19, further comprising:
generating second frame image data based on image data from the image source;
sequentially inputting the second frame image data for a first time to each pixel block of the display device, while transmitting the non-emission driving signal to each pixel of the display device during a third frame following the second frame; and
inputting the second frame image data for a second time to the pixels of each pixel row block of the display device, while transmitting the emission driving signal to each pixel of the display unit during a fourth frame following the third frame.
